(19) United States
(12) Patent Application Publication
(10) Pub. No.: US 2006/0168221 A1
(43) Pub. Date: Jul. 27, 2006

(54) Multi-domain access proxy for handling security issues in browser-based applications

(76) Inventors: Hauke Juhls, Stuttgart (DE); Andreas Seurig, Rottenburg (DE)

Correspondence Address: IBM CORPORATION;INTELLECTUAL PROPERTY LAW, 11400 BURNET ROAD, AUSTIN, TX, 78758, US

(21) Appl. No.: 11/269,263

(22) Filed: Nov. 8, 2005

(30) Foreign Application Priority Data
Dec. 29, 2004 (EP) 04107048.3

(51) Int. Cl. G06F 15/173

(52) U.S. Cl. 709/225; 709/238

(57) ABSTRACT

A request-based communications method, system and program product for overcoming security restrictions, in a networked environment having a client Web Browser (1), a first Webserver (4), and at least a second Webserver (5) which runs a web application (6) that acts as a back-end content resource (13), wherein within the run of an aggregated web application (2) the content resource is restricted to be accessed due to security restrictions being effective when an executable code downloaded from the first Webserver is executed in order to access said back-end content resource. The security restrictions are overcome by a) redirecting an incoming request issued by the client, to the second web server, and b) forwarding back the response to the request from the second web server to the client, which originally issued the request.

### 1. BACKGROUND OF THE INVENTION

1.1. Field of the Field

The present invention relates to networked computer applications, and in particular—according to the preamble of claim 1—to a method and system for programs—for example a JavaScript program that runs in a browser, wherein the browser represents a “security sandbox” preventing that such a program can access content from a server that is different from the server the program was downloaded from.

1.2. Description and Disadvantages of Prior art

With reference to FIG. 1, a prior art networked system environment is shown. A web browser 1 is used to participate in the running of web applications in the Internet. These web applications run on web servers 2.

In recent prior art there are web applications 2 that embed web pages delivered by other servers 5 into their web pages. The use of termini herein is as follows:

These web applications are called aggregating web applications 2, and the web page embedding the content is called aggregated web page 3. The aggregating web applications 2 are running on an aggregating web server 4. In a particular case, a server 5 is a so-called content web server.

Content web servers 5 host a content web application 6. This application delivers a web content 7 that is integrated into the aggregated web page 3.

An example for this scenario is a portal page of the aggregating server 2 showing a weather forecast. The web page containing the weather forecast is delivered by a separate content web server 5. This web page is integrated into the portal page. Thus, the environment is essentially defined by at least two servers 4, 5 and a client, communicating via a browser 1 in a network.

In prior art there are two different techniques for displaying content of the content web applications 6 on an aggregated web page 3, first the client side aggregation in so-called iFrames, second the server side aggregation.

As to prior art iFrames, briefly said, when an iFrame is present in a page, then another web page is loaded into the iFrame and displayed to user. This web page can originate from a different web server.

The client side aggregation works as follows:

The browser 1 requests the aggregated web page 3 from an aggregating web server 4, step 100 in FIG. 2.

The aggregating web server 4 constructs the aggregated web page 3, step 200. The URL of the web content 7 is written onto the aggregated web page 3 into an iFrame.

The aggregated web page 3 is sent back to the browser 1, step 300.

The browser 1 requests the web content 7 from the web content application 6 using the URL in the iFrame, step 350. The content web application 6 answers this request and sends back the web content 7, step 360. This web content 7 contains code 8 that will be executed in the browser.

The browser 1 displays the aggregated web page 3 to the user, leaving the space for the iFrame blank, step 400.

The browser 1 places the web content 7 into the iFrame, step 450.

As the web content 7 contains executable code 8, the browser starts executing the code 8 in the browser, step 500. If the code needs a network connection to the content web application it can open this connection, step 600.

The major drawback of this method is that frames (including iFrames) are considered security-vulnerable http://www.heise.de/security/news/meldung/48793

As to above-mentioned prior art Server side aggregation, to overcome the problem of the client side aggregation, content can be embedded by the server 4. The server side aggregation renders the use of iFrames unnecessary. The control flow is shown in FIG. 3:

In this case the browser 1 requests the aggregated web page 3 from the aggregating web server 4, step 100.

The aggregating web application 2 retrieves the web content 7 from the content web application 6, step 150.

The aggregating web application 2 embeds the content received in step 150 into the aggregated web page 3, step 200.

The aggregating web server 4 sends back the aggregated web page 3 constructed in step 200 to the browser 1, step 300.

The browser 1 displays the aggregated web page 3 to the user. This aggregated web page 3 now contains the web content 7 delivered by the content web application 6, step 400.

As already mentioned above, web content 7, however, may contain code that is executed in the browser 1, step 500. This code 8 is usually either written in JavaScript or in Java. The security concepts of both these languages deny any network communication between hosts that are different from the host where the web page was downloaded from.

This leads to a problem in the following situations:

First, when web content 7 of a content web application 6 is aggregated using the server side aggregation method described above; second, when the web content 7 contains code 8 that is executed in the browser 1;

Third, when the code 8 needs to communicate with the content web application 6, step 600;

Fourth, when the content web application 6 and the aggregating web application 2 are not running on the same server and on the same TCP port number.

If the web content contains code that needs network communication the code execution will continue as follows:

In step 500 the browser 1 received code 8 along with the aggregated web page 3 from the aggregating web server 4.

In step 600, when the code 8 is executed it tries to open a network connection 9 to the content web server 5 and tries to make a request.

In a further step the security concept of the browser 1 denies this network access 9, because only network connections to the aggregating web server 4 are allowed. Thus, the code 8 execution fails.

This is a major disadvantage of prior art.

### 1.3. OBJECTIVES OF THE INVENTION

It is thus an objective of the present invention to alleviate the disadvantages of prior art as described above.

### 2. SUMMARY AND ADVANTAGES OF THE INVENTION

This objective of the invention is achieved by the features stated in enclosed independent claims. Further advantageous arrangements and embodiments of the invention are set forth in the respective subclaims. Reference should now be made to the appended claims.

According to the broadest aspect of the present invention a request-based communication method in a networked environment between
an end-user associated client having a client URL and implementing a user interface via a Web Browser,
a first Webserver having a first server URL and communicating with the Web Browser of the client, and at least
a second Webserver having a second server URL, different to the first server URL and communicating with said first Webserver, which second web server (5) runs a web application that acts as a back-end content resource,
wherein within the run of an aggregated web application said content resource is restricted to be accessed by said end-user associated client Web Browser due to security restrictions being effective, when an executable code, for example a Java Code or a JavaScropt code, which is downloaded from said first Webserver, is executed in order to access said back-end content resource on said second Webserver,
   which is characterized by using a program means herein called a “Proxy servlet” for overcoming said security restrictions by performing the steps of:
a) changing the requestor address in a request incoming from the client at the first server and directed to access said back-end content resource, to be said first server URL,
b) forwarding said changed request to the second web server,
c) receiving a response to the forwarded request from the second web server comprising said second server URL as response address,
d) changing the response address to be the first server URL,
e) forwarding back the changed request to the client, which originally issued the request.

Thus, the general idea of the invention is to perform the steps of:
a) redirecting an incoming request issued by the client to the second web server, and
b) forwarding back the response to the request from the second web server to the client, which originally issued the request, wherein the addresses are exchanged in order to comply to the client browser's security restrictions, which refuses to execute a code loaded from said first server to be executed on said second server. A unique association between the redirected and the forwarded requests and the content web application is assured, for example by using a particular request ID.

This unique association is required if the back-end is a stateful web application. A possible association can be achieved through using a session id which is generated by the content web application 6. The content web application sends back the session id to the proxy servlet. The proxy servlet then stores this session id and will use it the next time it makes a request on behalf of the client. Using this technique may also reduce the number of login requests to the back-end application and may improve the overall performance.

A very common type of uses is present when the access to the back-end resource is done via executable code like Javascript, Java, etc. downloaded from either of the first or second server and invoked on the client browser 1.

The term” back-end” resource is to be understood broadly. It shall comprise hardware and software, which is not directly available at the first server, as it is hosted by one or more “second” server(s). Those second servers, may be differently administrated, differently located, and differently owned compared to the “first” server.

Further, the inventional basic method can be usefully enriched by an authentication procedure for a user at the client browser side. This is advantageous, as very often, the above-mentioned “back-end” resources offer limited access only, can thus be accessed, only after a successful user authentication. A typical reason may be that the requested services satisfied with the back-end resources are payable services, and/or there is a confidentiality binding in the use of these resources. Thus, often a user name and an associated password are required for accessing them. The Proxy servlet according to the invention can be advantageously used for performing the required user authentication against the content web server(s) providing so-called “single-sign-on” (SSO) experience for the user.

When further the back-end resource address is embedded as a parameter within the redirected request, an easy-to-use implementation can be achieved for situations, in which more than one “second” server shall be aggregated by the “first” aggregating server in the aggregating web application.

### 3. BRIEF DESCRIPTION OF THE DRAWINGS

The present invention is illustrated by way of example and is not limited by the shape of the figures of the drawings in which:

FIG. 1 is a schematic diagram showing a prior art system environment,

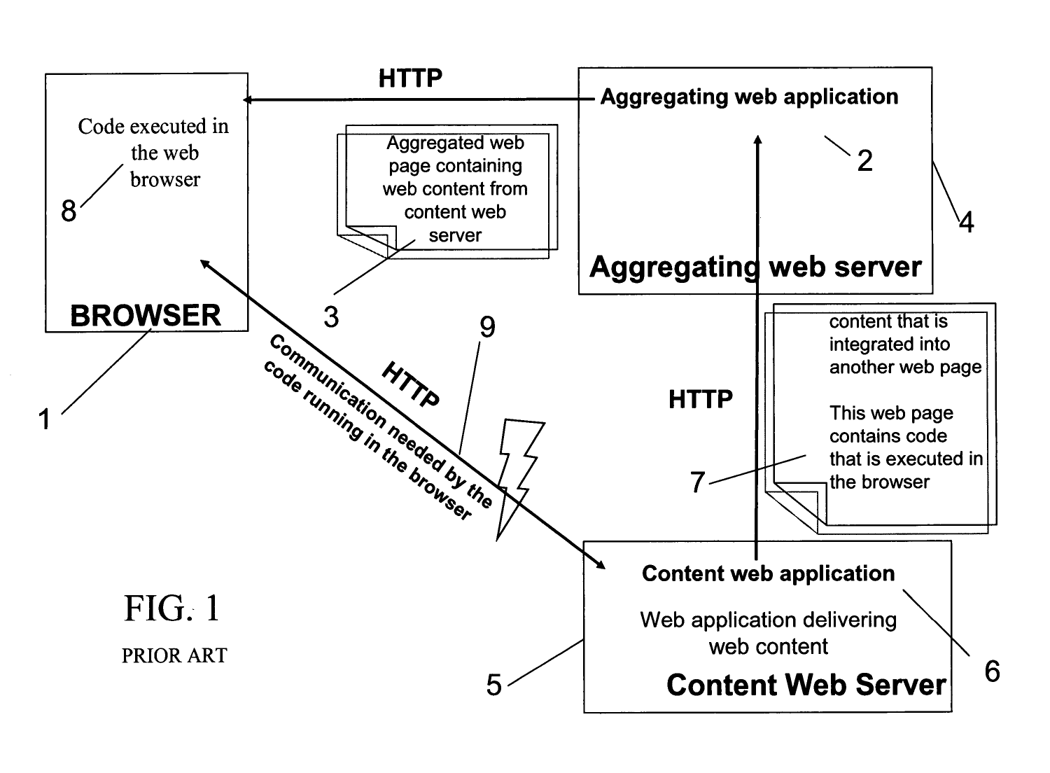

FIG. 2 is a schematic diagram showing the prior art control flow in client side content aggregation,

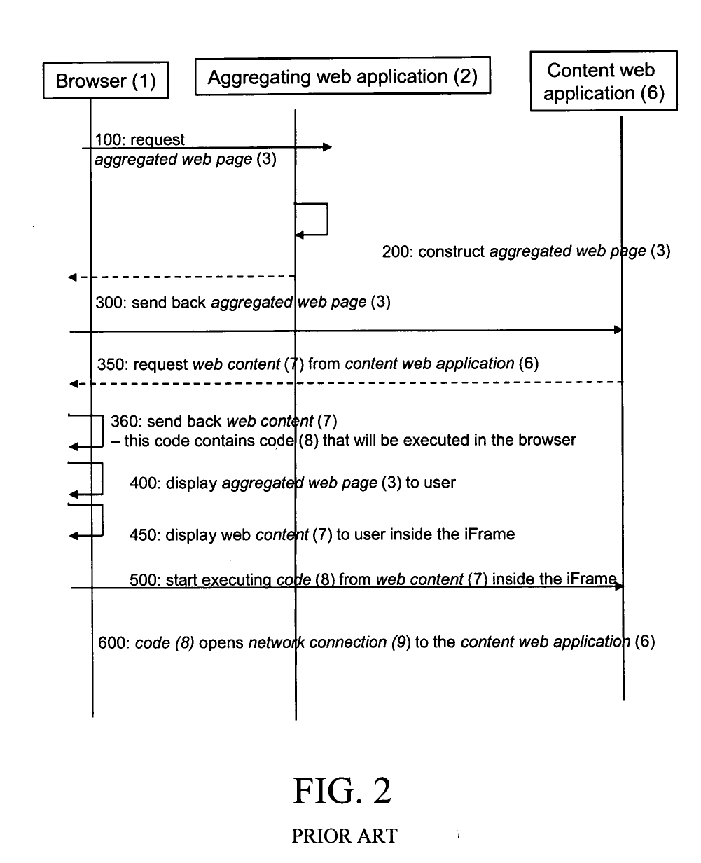

FIG. 3 is a schematic diagram showing the prior art control flow in server side content aggregation,

FIG. 4 is a schematic diagram showing a system environment in an inventional embodiment,

FIG. 5 is a schematic diagram showing the control flow in an inventional embodiment, and

FIG. 6 is a schematic diagram showing a system environment in a second inventional embodiment including security-protected back-end resources.

### 4. DETAILED DESCRIPTION OF THE PREFERRED EMBODIMENT

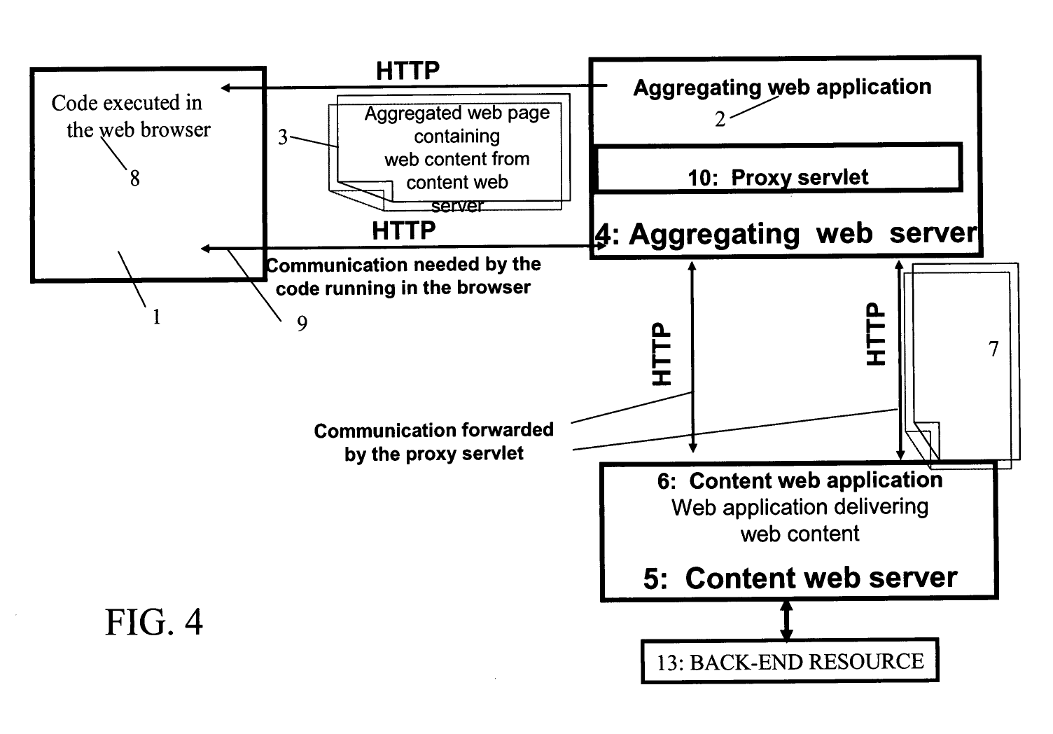

With general reference to the figures and with special reference now to FIG. 4, according to a preferred embodiment of the invention an additional web application 10, implemented for instance as a servlet, asp or cgi script is deployed onto the aggregating web application 2. This web application acts as a proxy and is called exemplarily herein a proxy servlet 10. The proxy servlet 10 is implemented to be enabled to receive requests of the client browser 1 made via HTTP. The proxy servlet 10 being accessed by the first server URL then issues the very same request to another second server being accessed by a second server URL, for instance the content web server 5. When this server replies, the proxy servlet 10 sends the very same response back as a response to the initial request it previously received. The URLs in the requests are changed by proxy 10 in order to comply with the security restrictions of the browser at the client.

This sequence can also be thought of as “forwarding”. The initial request is forwarded to another server and the response is forwarded back to the initial requestor.

If the server where the requests shall be forwarded to is changed from time to time, the proxy servlet 10 can be implemented in a way where a request parameter dedicated for this purpose determines the address of the server to where the request is to be forwarded.

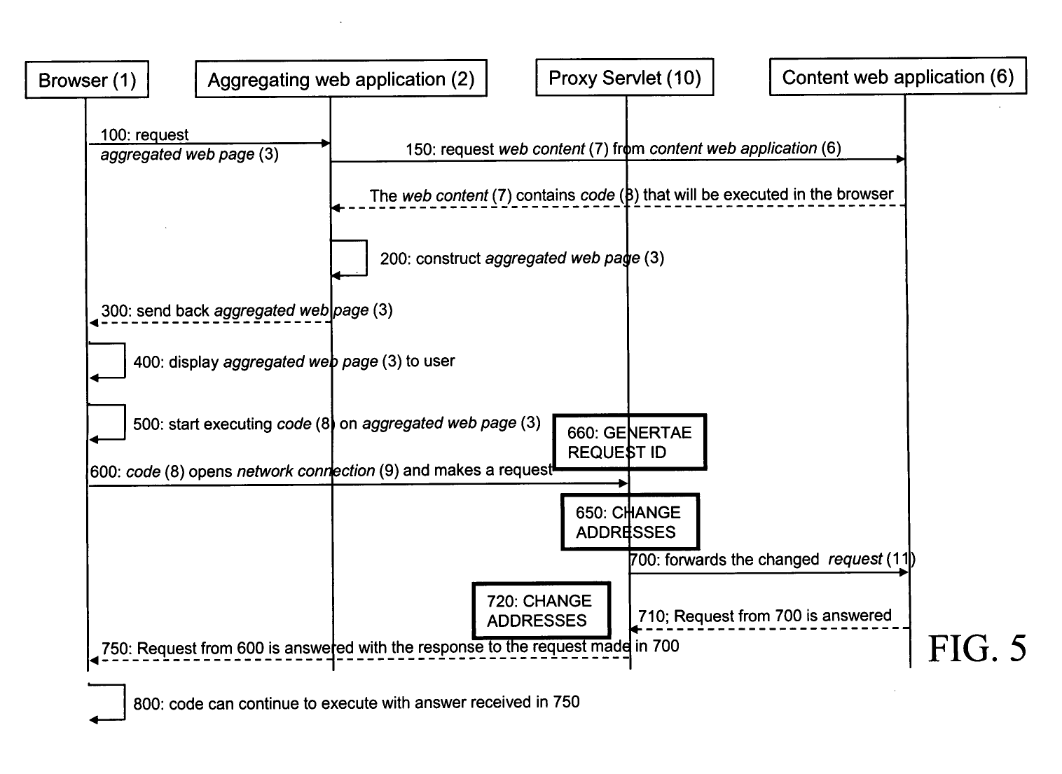

In order to use the proxy servlet 10 inserted according to this embodiment, with reference to FIG. 5 the following modifications are made to the above steps 500-700:

In step 500 the browser 1 receives the executable code 8 along with the aggregated web page 3 from the aggregating web server 4.

In step 600 the code 8 opens a network connection to the proxy servlet 10 and issues a request.

The proxy servlet 10 changes in a step 650 the URL of said request from that of the web application 2 (its own URL) to that one of the Content web application 6. Then, step 660, it generates a request ID, step 660, in order to control the states of the content web application.

In a step 700 the proxy servlet 10 forwards the request to the content web application 6. Thus, a redirection has been performed. It should be noted that the browser 1 permits this request because the request goes to the very same server the code came from, i.e. from the Proxy servlet 10.

Then in a next step the request is answered by the content web application 6 with another request comprising the requested content.

This request is received in step 710 and identified (see step 660 above) by the proxy servlet 10, which changes again the address from its own URL to that one of the client browser 1, see step 720.

In step 750 the proxy servlet 10 forwards the response back to the code 8 at the browser 1 as a response to the request made in 600.

In step 800 the code 1 receives the response and continues execution using the data received in step 700.

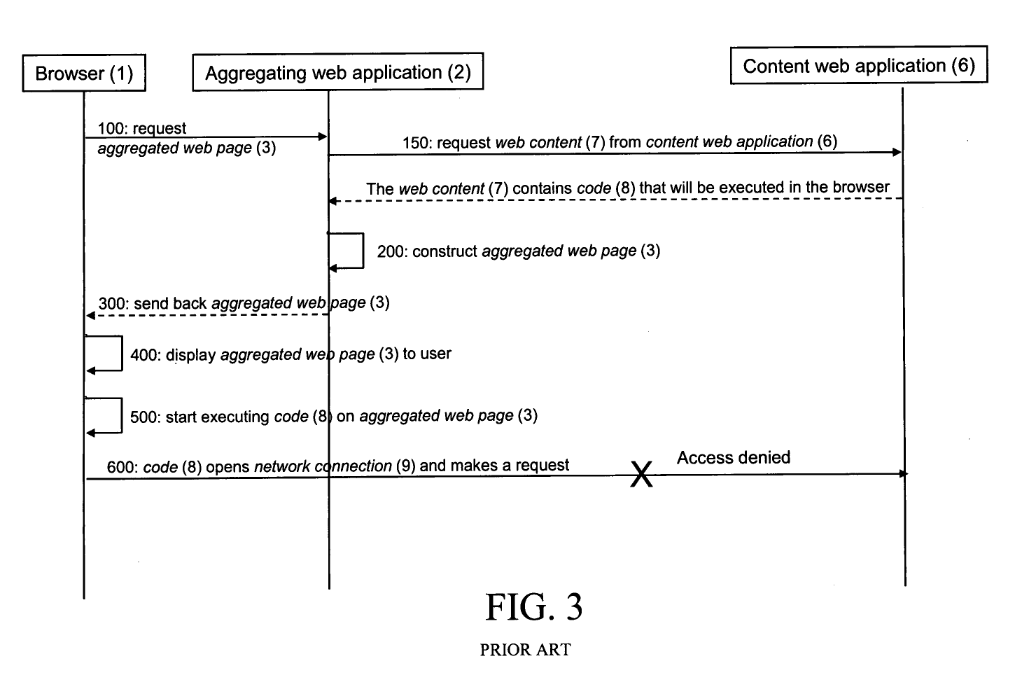

In the scenario without the inventional proxy servlet 10—see again FIG. 3 for reference—the code 8 execution failed in step 800 because the browser 1 denied the network communication 9 to the content web server 5.

Using the proxy servlet 10 enables the execution of the code 8 in step 800 because the network communication 9 is directed to the aggregating web server 4 and due to the fact that the proxy servlet 10—and not the client 1—opens the network communication 11 to the content web server 5.

The following system adaptations are required in an inventional implementation of above redirection method:

According to the invention the proxy servlet 10 or an equivalent thereof must be implemented and deployed on the aggregating web server 4. The proxy servlet 10 must be accessible via the same host name and the same port number as the aggregating web application 2.

The following code modifications can either be done manually or can be done by the aggregating web application 2.

The URL which is accessed by code 8 must be changed from the address of the content web application 6 to the address of the proxy servlet 10, see step 650 above.

An example in pseudo-code is as follows:

Original code:
connect to http://content.com/weather
Modified code:
connect to
http://aggregating.com/proxySrv?forwardTo=content.com/weather

Depending on the content it might become necessary to change the content the proxy servlet receives. This is the case if the web content contains references to resources (e.g. images, other web pages, etc . . .) that are stored on the content web server 5. These references must be modified so that they point to the proxy servlet. This modification can be done by pre-programmed code present at the proxy servlet 10.

The following example shows such an update in pseudo-code, assuming that weathermap.jpg is a resource on the content web server:

Original reference:
<img src=”/images/weathermap.jpg”/>
Modfified reference:
<img
src=http://aggregating.com/proxySrv?forwardTo=content.com/images
/weathermap.jpg/>

The following section describes the preferred use of the present invention:

The invention is essential for cases, where external applications are aggregated onto a web page. Thus, typically, portals often contain content from different sources. The aggregating web server 4 is the portal server in that case. Java 2 Enterprise Edition (J2EE)—based portal servers are well suited for the task, because the underlying J2EE Application Servers allow the deployment of additional web applications, such as an application containing the proxy servlet. The proxy Servlet can be realized as a Java servlet.

A sample application using this approach is a portal application for editing web content. This editor is running in the browser. The content that is processed by the editor is stored on a web server that is different from the portal server. This web server plays then the role of above-mentioned content web server 5. While the user makes modifications to the web content in the browser it might be necessary to request some resources e.g. images from the web server. Without a proxy servlet, i.e., in prior art, it would be impossible for the editor code to access these back-end resources because of above-mentioned “sand box security”, built-in on common browser programs. The editor code would not be able to access the web server because it can only access the portal server.

The inventional proxy servlet 10 can not only be used for retrieving such back-end resources, but also for uploading information. The editor can save the web page that is currently edited to the content web server in the background, while the user is using the editor.

Another advantage of using the proxy servlet is that it is possible to access different web servers 5 using the same proxy servlet. It also enables easily to move the aggregating web server 4 to a different address, because only the proxy servlet needs to be adapted while the original web application 6 remains unchanged.

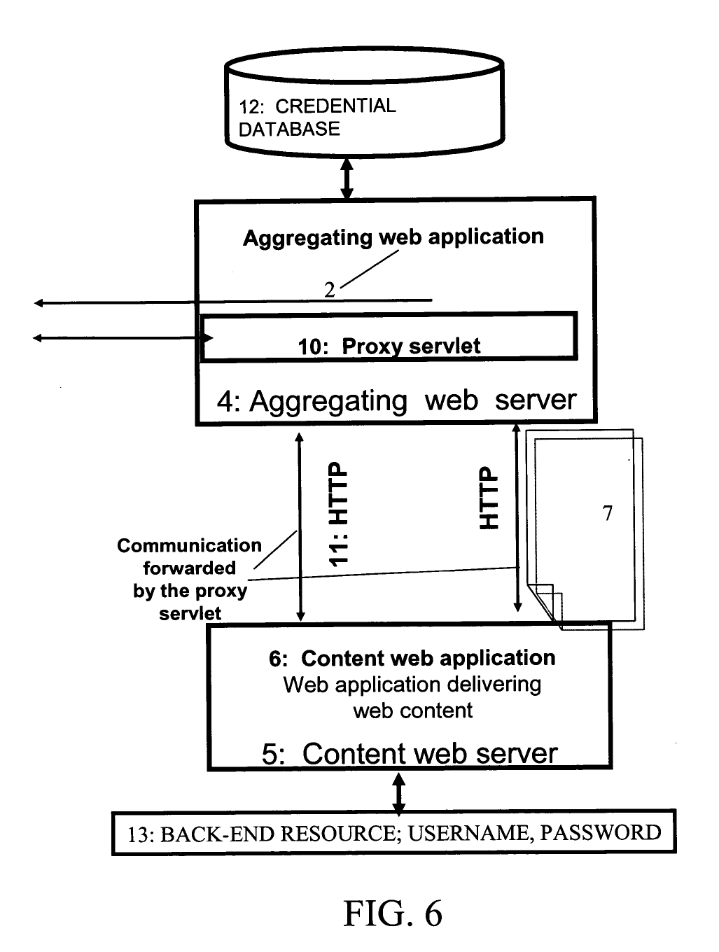

In a further variation, and with reference to FIG. 6, which shows a respective section of FIG. 4, the above-described procedure is enriched by a user authentication relevant for accessing the content resource 6.

Here, first a user logs-in at the portal server 4 by typing his user name and password.

In this particular embodiment the portal server 4 manages a prior art (IBM) “credential vault” service. The “credential vault” service provides single-sign-on (SSO) user experience by storing all credentials a user possesses. The Proxy servlet 10 implementing this inventional feature stores user name and password together with a unique security identifier (token) in a credential database 12. Then it sends this token back to the browser. This token can be considered a short-living, random alpha-numeric password that will become invalid after the session ends.

The browser receives that token.

Then the user is assumed to click to submit a request for a security-relevant, password-protected back-end resource 13, for example a scientific library, a music-, or a film “shop”.

In this case, the user request is received at the portal server together with the token, which is sent as a parameter in this request. The token is used as an index to lookup the user name and password in the credential database 12. Then a request to the “second” server 5 is issued comprising the user name and password. By that an access is enabled for this request and the password-protected resources can be used after a successful confirmation of these personal data at the server hosting the back-end resource.

After the use of that resource has been finished, the token is advantageously deleted without leaving traces to its recovery. This reduces the risk of abuse of such security tokens. For a new request a respective new token will be generated at the portal server.

The present invention can be realized in hardware, software, or a combination of hardware and software. A tool according to the present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following
a) conversion to another language, code or notation;
b) reproduction in a different material form.

1. A request-based communication method in a networked environment between
an end-user associated client having a client URL and implementing a user interface via a Web Browser (1),
a first Webserver (4) having a first server URL and communicating with the Web Browser (1) of the client, and at least
a second Webserver (5) having a second server URL, different to the first server URL and communicating with said first Webserver (4), which second web server (5) runs a web application (6) that acts as a back-end content resource (13),
wherein within the run of an aggregated web application (2) said content resource (13) is restricted to be accessed by said end-user associated client (1) Web Browser due to security restrictions being effective, when an executable code (8), which isdownloaded from said first Webserver, is executed in order to access said back-end content resource (13) on said second Webserver,
characterized by
using a program means (10) for overcoming said security restrictions by performing the steps of:
a) changing (650) the requestor address in a request incoming from the client at the first server and directed to access said back-end content resource (13), to be said first server URL;
b) forwarding said changed request as a redirected request to the second web, server (5);
c) receiving (710) a response to the forwarded request from the second web server (5) comprising said second server URL as response address;
d) changing (720) the response address to be the first server URL; and
e) forwarding back (750) the changed response to the changed request to the client, which originally issued the request.

2. The method according to claim 1, further comprising the step of generating (660) a unique association between said redirected request and said content resource (13) for controlling different states of the web application.

3. The method according to claim 1, wherein step b) comprises to embed the address of said content resource (13) as a parameter within said redirected request.

4. The method according to claim 1, wherein said content resources (13) are to be used by executable code (8) to be executed at said end-user associated client browser (1).

5. The method according to claim 1, further including the steps of:
a) receiving user-related security data;
b) storing said security data in a security database (12);
c) on a request for a security-protected content resource (13) looking up said security data in said database (12); and
d) including said security data into said redirected request for accessing said content resources.

6. A network server computer system (4) for use in a request-based communication method in a networked environment including;
an end-user associated client having a client URL and implementing a user interface via a Web Browser (1); and
a first Webserver (4) having a first server URL and communicating with the Web Browser (1) of the client, and at least
a second Webserver (5) having a second server URL, different to the first server URL and communicating with said first Webserver (4), which second web server (5) runs a web application (6) that acts as a back-end content resource (13),
wherein within the run of an aggregated web application (2) said content resource (13) is restricted to be accessed by said end-user associated client (1) Web Browser due to security restrictions being effective, when an executable code (8), which is downloaded from said first Webserver, is executed in order to access said back-end content resource (13) on said second Webserver,
said system (4) being characterized by a program means (10) having a functional component for overcoming said security restrictions by performing the steps of:
a) changing (650) the requestor address in a request incoming from the client at the first server and directed to access said back-end content resource (13), to be said first server URL,
b) forwarding said changed request as a redirected request to the second web server (5),
c) receiving (710) a response to the forwarded request from the second web server (5) comprising said second server URL as response address,
d) changing (720) the response address to be the first server URL,
e) forwarding back (750) the changed response to the changed request to the client, which originally issued the request.

7. (canceled)

8. A computer program product stored on a computer usable medium comprising computer readable program means for causing a computer to perform a request-based communication method in a networked environment between
an end-user associated client having a client URL and implementing a user interface via a Web Browser (1),
a first Webserver (4) having a first server URL and communicating with the Web Browser (1) of the client, and at least
a second Webserver (5) having a second server URL, different to the first server URL and communicating with said first Webserver (4), which second web server (5) runs a web application (6) that acts as a back-end content resource (13),
wherein within the run of an aggregated web application (2) said content resource (13) is restricted to be accessed by said end-user associated client (1) Web Browser due to security restrictions being effective, when an executable code (8), which is downloaded from said first Webserver, is executed in order to access said back-end content resource (13) on said second Webserver,
characterized by
said program product having a functional component for overcoming said security restrictions by performing the steps of:
a) changing (650) the requestor address in a request incoming from the client at the first server and directed to access said back-end content resource (13), to be said first server URL,
b) forwarding said changed request as a redirected request to the second web server (5),
c) receiving (710) a response to the forwarded request from the second web server (5) comprising said second server URL as response address,
d) changing (720) the response address to be the first server URL,
e) forwarding back (750) the changed response to the changed request to the client, which originally issued the request,
when said computer program product is executed on a computer.
